(19) United States
(12) Patent Application Publication
(10) Pub. No.: US 2022/0379321 A1
(43) Pub. Date: Dec. 1, 2022

(54) HANDHELD SHOWER HEAD

(71) Applicants: Jonah Edwards, Baltimore, MD (US); Shannon Edwards, Baltimore, MD (US)

(72) Inventors: Jonah Edwards, Baltimore, MD (US); Shannon Edwards, Baltimore, MD (US)

(21) Appl. No.: 17/335,924

(22) Filed: Jun. 1, 2021

(51) Int. Cl. B05B 1/18; E03C 1/046

(52) U.S. Cl. CPC B05B 1/185; E03C 1/0465

(57) ABSTRACT

A handheld shower head, including a liquid dispensing portion comprising a plurality of liquid apertures to dispense a liquid therefrom, a handle assembly disposed on at least a portion of the liquid dispensing portion to facilitate gripping thereof and to control a type of the liquid dispensed from the plurality of liquid apertures using a liquid setting, and a soap container detachably connected to at least a portion of the handle assembly to store a cleansing liquid therein and send the cleansing liquid through the handle assembly to the plurality of liquid apertures based on the liquid setting.

### BACKGROUND

### 1. Field

The present general inventive concept relates generally to showering, and particularly, to a handheld shower head.

### 2. Description of the Related Art

A shower is a common enclosure many people use for bathing. In modern society, it is even more important to cleanse a person's body to remove dirt and any potentially harmful pathogens. However, the act of taking a shower is challenging for some people, especially for those diagnosed with obesity and/or a physical disability.

Specifically, the shower is limited to having a shower head spray water on the person's body during use. Also, the user has to maneuver in the shower to obtain soap and/or shampoo for proper cleaning. These actions can be complicated and prolong the showering process.

Therefore, there is a need for a handheld shower head that can be manipulated by the user to reach multiple areas of the person's body, as well as includes soap during the shower.

### SUMMARY

The present general inventive concept provides a handheld shower head.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a handheld shower head, including a liquid dispensing portion comprising a plurality of liquid apertures to dispense a liquid therefrom, a handle assembly disposed on at least a portion of the liquid dispensing portion to facilitate gripping thereof and to control a type of the liquid dispensed from the plurality of liquid apertures using a liquid setting, and a soap container detachably connected to at least a portion of the handle assembly to store a cleansing liquid therein and send the cleansing liquid through the handle assembly to the plurality of liquid apertures based on the liquid setting.

The handle assembly may include a main portion, an extendable portion connected to at least a portion of the main portion, and an adjustment knob rotatably disposed between the main portion and the extendable portion to lock the main portion and the extendable portion in response to rotating in a first direction, and unlock the main portion and the extendable portion in response to rotating in a second direction.

The extendable portion may perform at least one of increasing in length and decreasing in length while the adjustment knob has moved in the second direction.

The handle assembly may further include a control switch slidably disposed on at least a portion of the main portion to prevent the plurality of liquid apertures from dispensing the liquid in response to being in a first position, allow the plurality of liquid apertures to dispense the cleansing liquid and water in response to being in a second position, and allow the plurality of liquid apertures to dispense only water in response to being in a third position.

The plurality of liquid apertures may increase a pressure level of the liquid dispensed therefrom in response to rotating in a first direction, and decreases the pressure level of the liquid dispensed therefrom in response to rotating in a second direction.

The handheld shower head may further include at least one sensor disposed within at least a portion of the liquid dispensing portion to detect a turbidity level within a predetermined distance from the at least one sensor, such that the plurality of liquid apertures increase a pressure level of the liquid dispensed therefrom in response to the at least one sensor detecting the turbidity level exceeds a predetermined turbidity level away from the at least one sensor.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a bottom perspective view of a handheld shower head, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Handheld Shower Head 100

Liquid Dispensing Portion 110

Liquid Apertures 111

Handle Assembly 120

Main Portion 121

Extendable Portion 122

Adjustment Knob 123

Control Switch 124

Soap Container 130

Hose Assembly 140

First Hose 141

Second Hose 142

Valve 143

Head Connector 150

Sensor 160

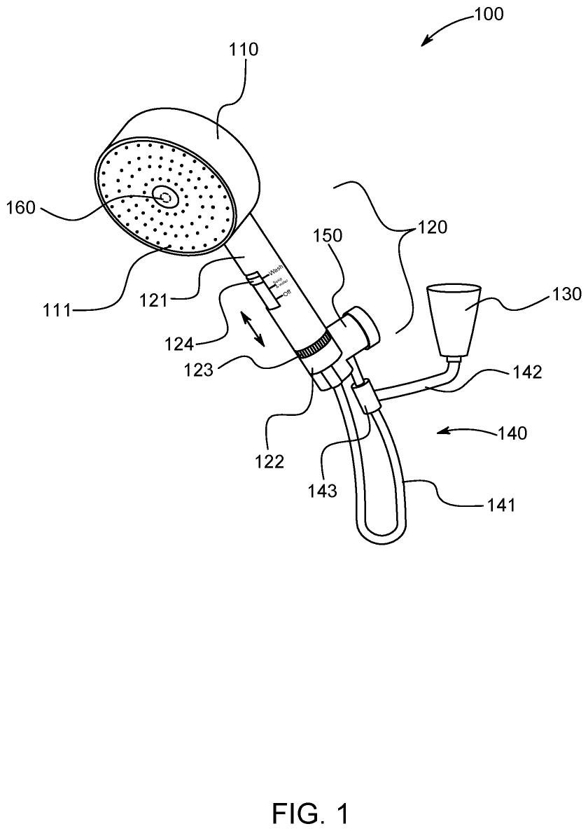

FIG. 1 illustrates a bottom perspective view of a handheld shower head 100, according to an exemplary embodiment of the present general inventive concept.

The handheld shower head 100 may be constructed from at least one of metal, plastic, glass, ceramic, and rubber, etc., but is not limited thereto.

The handheld shower head 100 may include a liquid dispensing portion 110, a handle assembly 120, a soap container 130, a hose assembly 140, a head connector 150, and at least one sensor 160, but is not limited thereto.

Referring to FIG. 1, the liquid dispensing portion 110 is illustrated to have a cylindrical shape. However, the liquid dispensing portion 110 may be a rectangular prism, circular, conical, triangular, pentagonal, hexagonal, heptagonal, octagonal, or any other shape known to one of ordinary skill in the art, but is not limited thereto.

The liquid dispensing portion 110 may include a plurality of liquid apertures 111, but is not limited thereto.

Referring again to FIG. 1, the plurality of liquid apertures 111 is illustrated to have a plurality. However, the plurality of liquid apertures 111 may be a single, circular liquid aperture 111. Also, it is important to note that the plurality of apertures 111 may be arranged in a series of concentric circles.

The plurality of liquid apertures 111 may be rotatably disposed on at least a portion of the liquid dispensing portion 110. Moreover, the plurality of liquid apertures 111 may dispense (i.e. spray) a liquid therefrom, such as water, soap, and/or shampoo. Furthermore, the plurality of liquid apertures 111 may be rotated in a first direction (i.e. clockwise) or a second direction (i.e. counterclockwise) to adjust a pressure level of the liquid dispensed therefrom (e.g., how hard the liquid is dispensed) and/or a number of the plurality of liquid apertures 111 dispensing the liquid. In other words, the plurality of liquid apertures 111 may be moved to increase and/or decrease the pressure level of the liquid, such that the liquid can create a massage sensation. For example, the plurality of liquid apertures 111 may rotate in the first direction to increase the pressure level of the liquid dispensed therefrom and/or increase the number of the plurality of liquid apertures 111 dispensing the liquid. Alternatively, the plurality of liquid apertures 111 may rotate in the second direction to decrease the pressure level of the liquid dispensed therefrom and/or decrease the number of the plurality of liquid apertures 111 dispensing the liquid.

The handle assembly 120 may include a main portion 121, an extendable portion 122, an adjustment knob 123, and a control switch 124, but is not limited thereto.

The main portion 121 may be disposed on at least a portion of the liquid dispensing portion 110. The extendable portion 122 may be connected through the adjustment knob 123 to at least a portion of the main portion 121. The main portion 121 and/or the extendable portion 122 may facilitate gripping thereof. Moreover, the adjustment knob 123 may be movably (i.e. rotatably) disposed between the main portion 121 and/or the extendable portion 122. The adjustment knob 123 may prevent (i.e. lock) movement of the main portion 121 and/or the extendable portion 122 in response to rotating in a first direction (i.e. clockwise) and facilitate (i.e. unlock) movement of the main portion 121 and/or the extendable portion 122 in response to rotating in a second direction (i.e. counterclockwise). As such, the main portion 121 and/or the extendable portion 122 may move at least partially away from each other in response to rotating the adjustment knob 123 in the second direction. In other words, the extendable portion 122 may increase in length (i.e. extend). Alternatively, the main portion 121 and/or the extendable portion 122 may move toward each other to decrease the length of the extendable portion 122 (i.e. contract) while the adjustment knob 123 has been moved in the second direction.

The control switch 124 may be movably (i.e. slidably) disposed on at least a portion of the main portion 121. The control switch 124 may adjust a type of the liquid dispensed from the plurality of liquid apertures 111. More specifically, the control switch 124 may have a liquid setting based on sliding to a first position, a second position, and/or a third position. The control switch 124 may prevent the plurality of liquid apertures 111 from dispensing the liquid in response to being in the first position (i.e. off). The control switch 124 may allow the plurality of liquid apertures 111 to dispense the liquid (e.g., soap and/or water) in response to being in the second position. Finally, the control switch 124 may allow the plurality of liquid apertures 111 to dispense only water in response to being in the third position.

The soap container 130 may be detachably connected to at least a portion of the handle assembly 120. The soap container 130 may store a cleansing liquid, such as the soap and/or the shampoo therein. However, the soap container 130 may be removed to allow different soaps and/or shampoos to be inserted therein. Also, the soap container 130 may send the cleansing liquid through the handle assembly 120 to the plurality of liquid apertures 111 in response to the liquid setting, such as moving the control switch 124 to the second position.

The hose assembly 140 may include a first hose 141, a second hose 142, and a valve 143, but is not limited thereto.

The first hose 141 may be connected at a first end to the handle assembly 120. The second hose 142 may be connected at a first end to the soap container 130 and connected at a second end to the valve 143. The valve 143 may connect the first hose 141 to the second hose 142. However, the valve 143 may regulate a flow of soap into the first hose 141 based on the control switch 124. In other words, the valve 143 may be mechanically connected to the control switch 124.

The head connector 150 may be connected to at least a portion of a surface (e.g., a wall) and a water pipe to receive the water therein. Additionally, the head connector 150 may be connected to a second end of the first hose 141. As such, the first hose 141 may receive the water from the head connector 150. Furthermore, the handle assembly 120 may be detachably connected to the head connector 150. In other words, the liquid dispensing portion 110 and/or the handle assembly 120 may be removed from the head connector 150 to be moved around a body of a user, such that the user may control where the plurality of liquid apertures 111 dispenses the liquid.

Accordingly, the hose assembly 140 may connect the handle assembly 120 to the soap container 130 and/or the head connector 150.

The at least one sensor 160 may include a turbidity sensor, but is not limited thereto.

The at least one sensor 160 may be disposed within at least a portion of the liquid dispensing portion 110. The at least one sensor 160 may detect a turbidity level within a predetermined distance (e.g., one inch, two inches, fives inches, ten inches, etc.) from the at least one sensor 160, such as the liquid splashing on the body of the user. The plurality of liquid apertures 111 may increase the pressure level of the liquid dispensed therefrom in response to the at least one sensor 160 detecting the turbidity level exceeds a predetermined turbidity level (e.g., dirt, mud) away from the at least one sensor 160, such as on the body of the user. Also, the plurality of liquid apertures 111 may decrease the pressure level of the liquid dispensed therefrom in response to the at least one sensor 160 detecting the turbidity level remains and/or has dropped below the predetermined turbidity level. It is to be understood that this feature operates independently from rotating the plurality of liquid apertures 111 described above.

The at least one sensor 160 may adjust individual liquid apertures 111 to dispense the liquid at different pressure levels depending on an area from the plurality of liquid apertures 111 has more turbidity. For example, a top portion of the liquid dispensing portion 110 may have higher turbidity than a bottom portion, and, therefore, the liquid apertures 111 at the top portion may have a higher pressure level than the bottom portion.

Therefore, the handheld shower head 100 may be moved by the user to target specific areas of the body for cleansing. Also, the handheld shower head 100 may facilitate the cleansing process by allowing soap to be dispensed in the water simultaneously.

The present general inventive concept may include a handheld shower head 100, including a liquid dispensing portion 110 comprising a plurality of liquid apertures 111 to dispense a liquid therefrom, a handle assembly 120 disposed on at least a portion of the liquid dispensing portion 110 to facilitate gripping thereof and to control a type of the liquid dispensed from the plurality of liquid apertures 111 using a liquid setting, and a soap container 130 detachably connected to at least a portion of the handle assembly 120 to store a cleansing liquid therein and send the cleansing liquid through the handle assembly 120 to the plurality of liquid apertures 111 based on the liquid setting.

The handle assembly 120 may include a main portion 121, an extendable portion 122 connected to at least a portion of the main portion 121, and an adjustment knob 123 rotatably disposed between the main portion 121 and the extendable portion 122 to lock the main portion and the extendable portion 122 in response to rotating in a first direction, and unlock the main portion 121 and the extendable portion 122 in response to rotating in a second direction.

The extendable portion 122 may perform at least one of increasing in length and decreasing in length while the adjustment knob 123 has moved in the second direction.

The handle assembly 120 may further include a control switch 124 slidably disposed on at least a portion of the main portion 121 to prevent the plurality of liquid apertures 111 from dispensing the liquid in response to being in a first position, allow the plurality of liquid apertures 111 to dispense the cleansing liquid and water in response to being in a second position, and allow the plurality of liquid apertures 111 to dispense only water in response to being in a third position.

The plurality of liquid apertures 111 may increase a pressure level of the liquid dispensed therefrom in response to rotating in a first direction, and decreases the pressure level of the liquid dispensed therefrom in response to rotating in a second direction.

The handheld shower head 100 may further include at least one sensor 160 disposed within at least a portion of the liquid dispensing portion 110 to detect a turbidity level within a predetermined distance from the at least one sensor 160, such that the plurality of liquid apertures 111 increase a pressure level of the liquid dispensed therefrom in response to the at least one sensor 160 detecting the turbidity level exceeds a predetermined turbidity level away from the at least one sensor 160.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A handheld shower head, comprising:
a liquid dispensing portion comprising a plurality of liquid apertures to dispense a liquid therefrom;
a handle assembly disposed on at least a portion of the liquid dispensing portion to facilitate gripping thereof and to control a type of the liquid dispensed from the plurality of liquid apertures using a liquid setting; and
a soap container detachably connected to at least a portion of the handle assembly to store a cleansing liquid therein and send the cleansing liquid through the handle assembly to the plurality of liquid apertures based on the liquid setting.

2. The handheld shower head of claim 1, wherein the handle assembly comprises:
a main portion;
an extendable portion connected to at least a portion of the main portion; and
an adjustment knob rotatably disposed between the main portion and the extendable portion to lock the main portion and the extendable portion in response to rotating in a first direction, and unlock the main portion and the extendable portion in response to rotating in a second direction.

3. The handheld shower head of claim 2, wherein the extendable portion performs at least one of increasing in length and decreasing in length while the adjustment knob has moved in the second direction.

4. The handheld shower head of claim 2, wherein the handle assembly further comprises:
a control switch slidably disposed on at least a portion of the main portion to prevent the plurality of liquid apertures from dispensing the liquid in response to being in a first position, allow the plurality of liquid apertures to dispense the cleansing liquid and water in response to being in a second position, and allow the plurality of liquid apertures to dispense only water in response to being in a third position.

5. The handheld shower head of claim 1, wherein the plurality of liquid apertures increases a pressure level of the liquid dispensed therefrom in response to rotating in a first direction, and decreases the pressure level of the liquid dispensed therefrom in response to rotating in a second direction.

6. The handheld shower head of claim 1, further comprising:
at least one sensor disposed within at least a portion of the liquid dispensing portion to detect a turbidity level within a predetermined distance from the at least one sensor, such that the plurality of liquid apertures increase a pressure level of the liquid dispensed therefrom in response to the at least one sensor detecting the turbidity level exceeds a predetermined turbidity level away from the at least one sensor.
